(19) United States
(12) Patent Application Publication
(10) Pub. No.: US 2026/0095862 A1
(43) Pub. Date: Apr. 2, 2026

(54) WAKE UP RADIO ASSISTED COMMUNICATION DURING POWER MODE TRANSITION

(71) Applicant: QUALCOMM Incorporated, San Diego, CA (US)

(72) Inventors: Ahmed ELSHAFIE, San Diego, CA (US); Diana MAAMARI, San Diego, CA (US); Huilin XU, Temecula, CA (US); Linhai HE, San Diego, CA (US); Prashant SHARMA, San Marcos, CA (US); Wei YANG, San Diego, CA (US); Yuchul KIM, San Diego, CA (US); Chao WEI, Beijing (CN)

(21) Appl. No.: 19/108,974

(22) PCT Filed: Oct. 12, 2022
(86) PCT No.: PCT/CN2022/124773

§ 371 Date: Mar. 5, 2025

(51) Int. Cl. H04W 52/02; H04W 88/06

(52) U.S. Cl. CPC H04W 52/0235; H04W 52/0216; H04W 52/028; H04W 88/06

(57) ABSTRACT

Various aspects of the present disclosure generally relate to wireless communication. In some aspects, a user equipment (UE) may receive, using a first radio component, a wake up signal indicating a transition of a second radio component from a reduced power mode to another power mode. The UE may receive, using the first radio component and during the transition of the second radio component from the reduced power mode to the other power mode, one or more signals. The UE may communicate, after the transition of the second radio component from the reduced power mode to the other power mode, using the second radio component and in accordance with the one or more signals. Numerous other aspects are described.

### FIELD OF THE DISCLOSURE

Aspects of the present disclosure generally relate to wireless communication and to techniques and apparatuses for wake up radio assisted communication during power mode transition.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to receive, using a first radio component, a wake up signal indicating a transition of a second radio component from a reduced power mode to another power mode or a configuration. The one or more processors may be configured to receive, using the first radio component and during the transition of the second radio component from the reduced power mode to the other power mode or based at least in part on the configuration, one or more signals. The one or more processors may be configured to communicate, after the transition of the second radio component from the reduced power mode to the other power mode or after receiving the configuration, using the second radio component and in accordance with the one or more signals.

Some aspects described herein relate to a network node for wireless communication. The network node may include a memory and one or more processors coupled to the memory. The one or more processors may be configured to transmit, on a first band associated with a first radio component of a user equipment (UE), a wake up signal indicating a transition of a second radio component of the UE from a reduced power mode to another power mode or a configuration. The one or more processors may be configured to transmit, on the first band during the transition of the second radio component from the reduced power mode to the other power mode, one or more signals or based at least in part on the configuration. The one or more processors may be configured to communicate, after the transition of the second radio component from the reduced power mode to the other power mode or after transmitting the configuration, on a second band associated with the second radio component and in accordance with the one or more signals.

Some aspects described herein relate to a method of wireless communication performed by a user equipment (UE). The method may include receiving, using a first radio component, a wake up signal indicating a transition of a second radio component from a reduced power mode to another power mode or a configuration. The method may include receiving, using the first radio component and during the transition of the second radio component from the reduced power mode to the other power mode or based at least in part on the configuration, one or more signals. The method may include communicating, after the transition of the second radio component from the reduced power mode to the other power mode or after receiving the configuration, using the second radio component and in accordance with the one or more signals.

Some aspects described herein relate to a method of wireless communication performed by a network node. The method may include transmitting, on a first band associated with a first radio component of a user equipment (UE), a wake up signal indicating a transition of a second radio component of the UE from a reduced power mode to another power mode or a configuration. The method may include transmitting, on the first band during the transition of the second radio component from the reduced power mode to the other power mode or based at least in part on the configuration, one or more signals. The method may include communicating, after the transition of the second radio component from the reduced power mode to the other power mode or after receiving the configuration, on a second band associated with the second radio component and in accordance with the one or more signals.

Some aspects described herein relate to a method of wireless communication performed by an apparatus of a user equipment (UE). The method may include receiving, using a first radio component, a wake up signal indicating a transition of a second radio component from a reduced power mode to another power mode. The method may include receiving, using the first radio component and during the transition of the second radio component from the reduced power mode to the other power mode, one or more signals. The method may include communicating, after the transition of the second radio component from the reduced power mode to the other power mode, using the second radio component and in accordance with the one or more signals.

Some aspects described herein relate to a method of wireless communication performed by an apparatus of a network node. The method may include transmitting, on a first band associated with a first radio component of a UE, a wake up signal indicating a transition of a second radio component of the UE from a reduced power mode to another power mode. The method may include transmitting, on the first band during the transition of the second radio component from the reduced power mode to the other power mode, one or more signals. The method may include communicating, after the transition of the second radio component from the reduced power mode to the other power mode, on a second band associated with the second radio component and in accordance with the one or more signals.

Some aspects described herein relate to a UE for wireless communication. The UE may include a memory and one or more processors coupled to the memory. The one or more processors may be configured to receive, using a first radio component, a wake up signal indicating a transition of a second radio component from a reduced power mode to another power mode. The one or more processors may be configured to receive, using the first radio component and during the transition of the second radio component from the reduced power mode to the other power mode, one or more signals. The one or more processors may be configured to communicate, after the transition of the second radio component from the reduced power mode to the other power mode, using the second radio component and in accordance with the one or more signals.

Some aspects described herein relate to a network node for wireless communication. The network node may include a memory and one or more processors coupled to the memory. The one or more processors may be configured to transmit, on a first band associated with a first radio component of a UE, a wake up signal indicating a transition of a second radio component of the UE from a reduced power mode to another power mode. The one or more processors may be configured to transmit, on the first band during the transition of the second radio component from the reduced power mode to the other power mode, one or more signals. The one or more processors may be configured to communicate, after the transition of the second radio component from the reduced power mode to the other power mode, on a second band associated with the second radio component and in accordance with the one or more signals.

Some aspects described herein relate to a non-transitory computer-readable medium that stores a set of instructions for wireless communication by a UE. The set of instructions, when executed by one or more processors of the UE, may cause the UE to receive, using a first radio component, a wake up signal indicating a transition of a second radio component from a reduced power mode to another power mode. The set of instructions, when executed by one or more processors of the UE, may cause the UE to receive, using the first radio component and during the transition of the second radio component from the reduced power mode to the other power mode, one or more signals. The set of instructions, when executed by one or more processors of the UE, may cause the UE to communicate, after the transition of the second radio component from the reduced power mode to the other power mode, using the second radio component and in accordance with the one or more signals.

Some aspects described herein relate to a non-transitory computer-readable medium that stores a set of instructions for wireless communication by a network node. The set of instructions, when executed by one or more processors of the network node, may cause the network node to transmit, on a first band associated with a first radio component of a UE, a wake up signal indicating a transition of a second radio component of the UE from a reduced power mode to another power mode. The set of instructions, when executed by one or more processors of the network node, may cause the network node to transmit, on the first band during the transition of the second radio component from the reduced power mode to the other power mode, one or more signals. The set of instructions, when executed by one or more processors of the network node, may cause the network node to communicate, after the transition of the second radio component from the reduced power mode to the other power mode, on a second band associated with the second radio component and in accordance with the one or more signals.

Some aspects described herein relate to an apparatus for wireless communication.

The apparatus may include means for receiving, using a first radio component, a wake up signal indicating a transition of a second radio component from a reduced power mode to another power mode. The apparatus may include means for receiving, using the first radio component and during the transition of the second radio component from the reduced power mode to the other power mode, one or more signals. The apparatus may include means for communicating, after the transition of the second radio component from the reduced power mode to the other power mode, using the second radio component and in accordance with the one or more signals.

Some aspects described herein relate to an apparatus for wireless communication.

The apparatus may include means for transmitting, on a first band associated with a first radio component of a UE, a wake up signal indicating a transition of a second radio component of the UE from a reduced power mode to another power mode. The apparatus may include means for transmitting, on the first band during the transition of the second radio component from the reduced power mode to the other power mode, one or more signals. The apparatus may include means for communicating, after the transition of the second radio component from the reduced power mode to the other power mode, on a second band associated with the second radio component and in accordance with the one or more signals.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a transmit (Tx) chain and a receive (Rx) chain of a UE, in accordance with the present disclosure.

FIG. 5 is a diagram illustrating an example of wake up signaling, in accordance with the present disclosure.

FIGS. 6A-6F are diagrams illustrating an example associated with wake up radio assisted communication during power mode transition, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

FIG. 11 is a diagram illustrating an example of wake up signaling, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

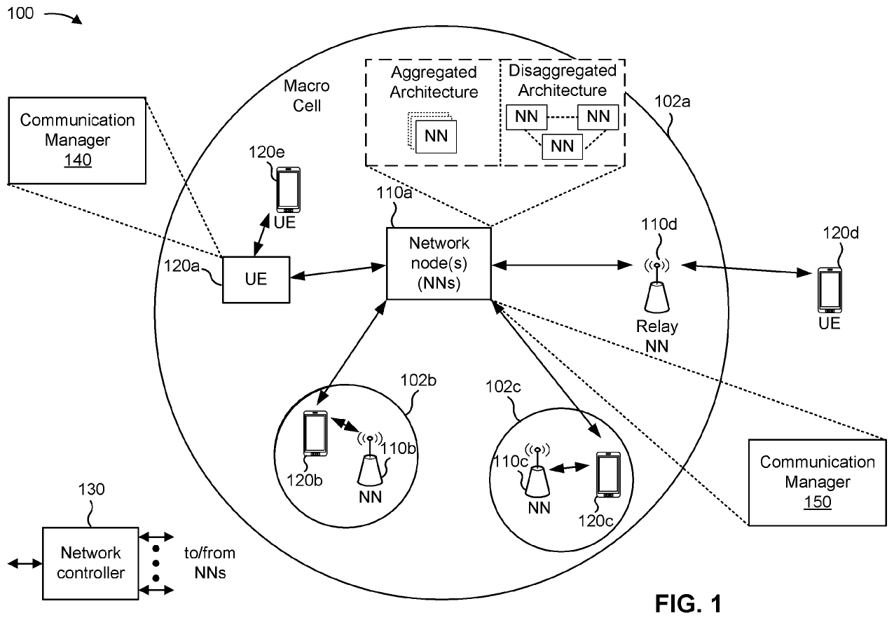

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

Some UEs 120 may perform radio resource management (RRM) measurements. The RRM measurements may be associated with an RRM configuration, as described in more detail herein. However, in some scenarios, it may be desirable to change RRM configuration. RRM relaxation has been introduced to allow for adjusting of an RRM configuration (or switching between RRM configurations). In RRM relaxation, a UE 120 may switch from measurement in accordance with a first set of parameters to measurement in accordance with a second set of parameters and/or to skipping one or more measurements entirely. Two examples of when RRM relaxation may be triggered are in scenarios where the UE 120 has low mobility and scenarios when the UE 120 is at a cell edge. One example for determining when the UE 120 is in a low mobility scenario is when (Srxlev_{Ref}−Srxlev)<S_{searchDeltaP} for a period of time T_{SearchDeltaP}. One example for determining when the UE 120 is at a cell edge is when Srxlev≤S_{searchThresholdP} and/or Squal≤S_{searchThresholdQ} (if a value for S_{searchThresohldQ} is configured). The network node 110 may configure the aforementioned example criteria (e.g., one or more of the criteria or another set of criteria) for the UE 120 to determine when to trigger RRM relaxation. In one scenario, when the UE 120 triggers RRM relaxation, the UE 120 may relax measurements (e.g., switch to an RRM relaxation configuration) for an interval associated with a scaling factor, as described in more detail in 3GPP Technical Specification (TS) 38.133. In a second scenario, when the UE 120 triggers RRM relaxation, the UE 120 may stop measurements (e.g., measurements associated with RRM or all measurements entirely) for up to a set period of time (e.g., 1 hour). The UE 120 may choose one or more of the aforementioned relaxation scenarios (or another relaxation scenario that is configured) based at least in part on different triggering criteria (e.g., whether a single triggering criterion is met, whether a plurality of triggering criteria are met, or which triggering criteria is/are met, among other examples). Additionally, or alternatively, the UE 120 may choose which measurements, among other parameters, to subject to the RRM relaxation, such as intra-frequency measurements, inter-frequency measurements (e.g., with a particular priority level), inter-RAT measurements, etc.

When a UE 120 operates in idle states (RRC-IDLE or RRC-INACTIVE) or connected states, the UE 120 may perform RRM measurement, cell re-selection (if triggered), and/or paging monitoring every I-DRX or C-DRX based RRC state. The RRM measurements may include both serving cell and neighbor cell measurements. Whether the UE 120 is to perform neighbor cell measurements is determined by a serving cell status (e.g., neighbor cell RRM may starts when a serving cell channel quality does not satisfy one or more configured conditions). For the serving cell measurement, a UE 120 may measure a synchronization signal (SS) reference signal received (RSRP) (SS-RSRP) and an SS reference signal received quality (RSRQ) (SS-RSRQ) level of a serving cell and may evaluate a cell selection criterion S (which may be described in more detail in 3GPP TS 38.304) for the serving cell at least once every M1*N1 DRX cycle; where: M1=2 if an SS/PBCH block measurement timing configuration (SMTC) periodicity, TSMTC, is greater than 20 milliseconds and a discontinuous reception (DRX) cycle is or equal to 0.64 seconds (otherwise M1=1). Additional details of the serving cell measurement are described in 3GPP TS 38.133. The value of N1 is different for different frequency bands (FR1 and FR2, as described herein). For FR1, N1 is equal to 1. Therefore, a UE 120 may perform serving cell measurement every 1 or 2 paging DRX cycles. Accordingly, the main power consumption for UEs in an idle or inactive state is from RRM measurement.

In 3GPP release 16 (Rel-16), the relaxing of RRM measurement for intra-frequency or inter-frequency/inter-RAT frequency measurement is allowed for UEs not at a cell edge and/or with low mobility. In 3GPP release 17 (Rel-17), additional relaxation measurement criteria are configured, such as for supporting stationary RedCap UEs. However, no relaxation may be configured for the serving cell RRM. This may be because the serving cell RSRP/RSRQ measurement may be more important than the aforementioned measurements and used to evaluate neighbor cell RRM relaxation. The configuration of RRM measurement, RRM relaxation, and/or RRM offloading may be based at least in part on a radio resource control (RRC) state of the UE. Similarly, low-power wake up signals (LP-WUSs), as described herein, and low-power update occasion contents and configurations (e.g., waveform, modulation, coding, repetition, periodicity, monitoring occasions, or timers), as described herein, may be based at least in part on an RRC state of the UE.

When a low-power (LP) wake up radio (WUR) LP-WUR is introduced, one option is that the LP-WUR monitors wake up signals (WUSs) and RRM measurement is still done by a main radio (MR). However, the power saving gain may not be high since the MR may frequently wake up for the serving cell measurement. In such a scenario, the serving cell RRM can be a bottleneck for power saving since no relaxation is supported.

Another option is to relax serving cell RRM measurement or offload some RRM functionalities to the LP-WUR. However, as described above, the relaxing of RRM measurements is configured for UEs at a cell edge or with low mobility. Accordingly, if such restrictions apply for the serving cell RRM relaxation, UEs away from a cell edge or not satisfying a low mobility criterion may have to frequently wake up the MR for RRM measurement. In this case, the power saving gain from LP-WUR is limited. Therefore, offloading some RRM measurement functionality to LP-WUR is desirable.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, using a first radio component, a wake up signal indicating a transition of a second radio component from a reduced power mode to another power mode; receive, using the first radio component and during the transition of the second radio component from the reduced power mode to the other power mode, one or more signals; and communicate, after the transition of the second radio component from the reduced power mode to the other power mode, using the second radio component and in accordance with the one or more signals. Additionally, or alternatively, the communication manager 140 may perform one or more other operations described herein.

In some aspects, the network node 110 may include a communication manager 150. As described in more detail elsewhere herein, the communication manager 150 may transmit, on a first band associated with a first radio component of a UE, a wake up signal indicating a transition of a second radio component of the UE from a reduced power mode to another power mode; transmit, on the first band during the transition of the second radio component from the reduced power mode to the other power mode, one or more signals; and communicate, after the transition of the second radio component from the reduced power mode to the other power mode, on a second band associated with the second radio component and in accordance with the one or more signals. Additionally, or alternatively, the communication manager 150 may perform one or more other operations described herein.

As indicated above, FIG. 1 is provided as an example. Other examples may differ from what is described with regard to FIG. 1.

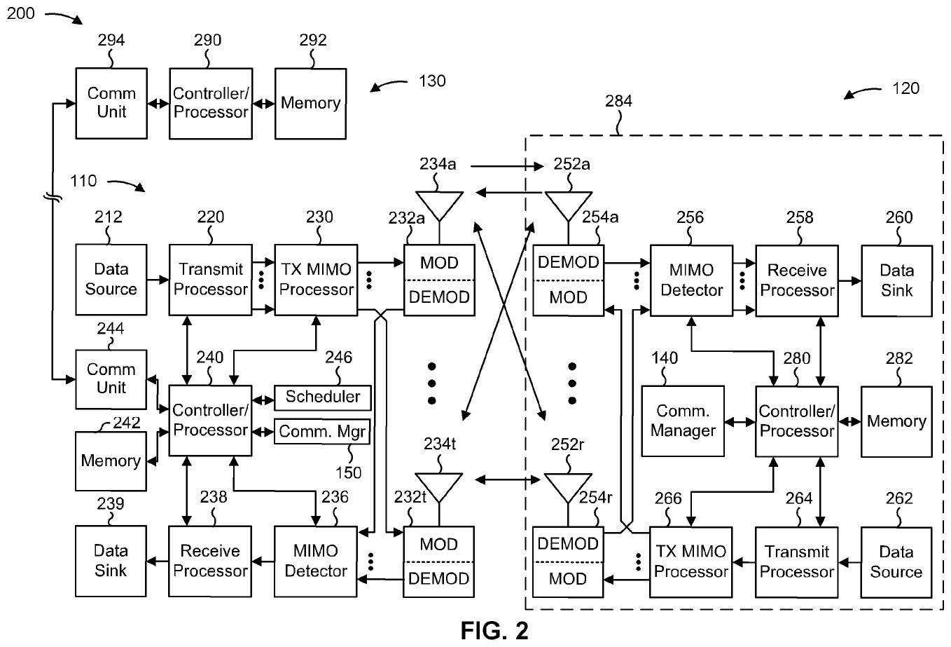

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

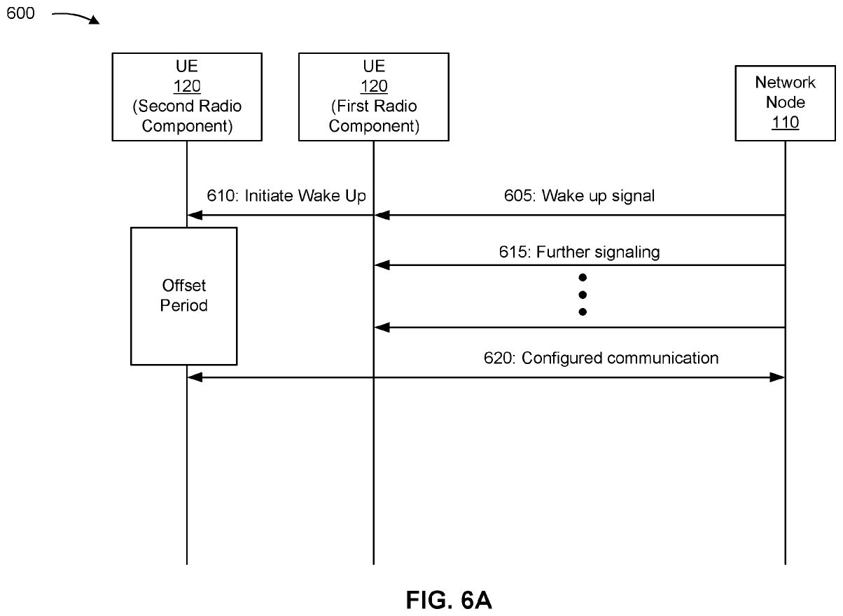

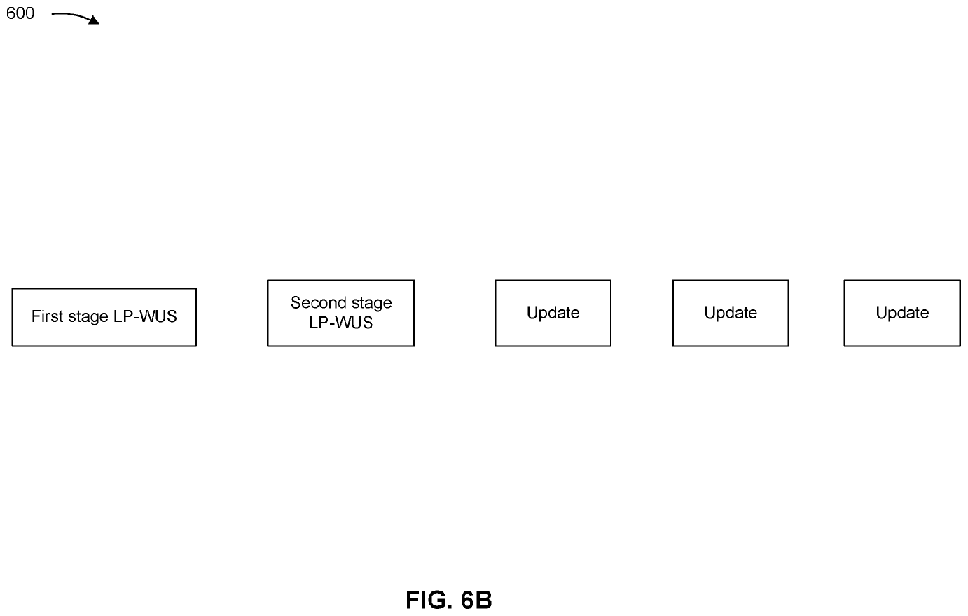

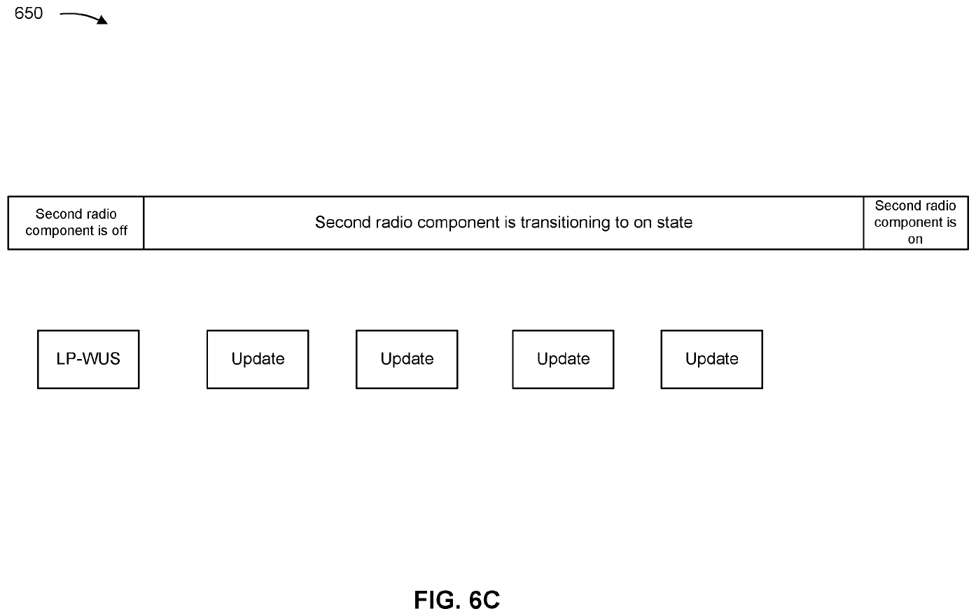

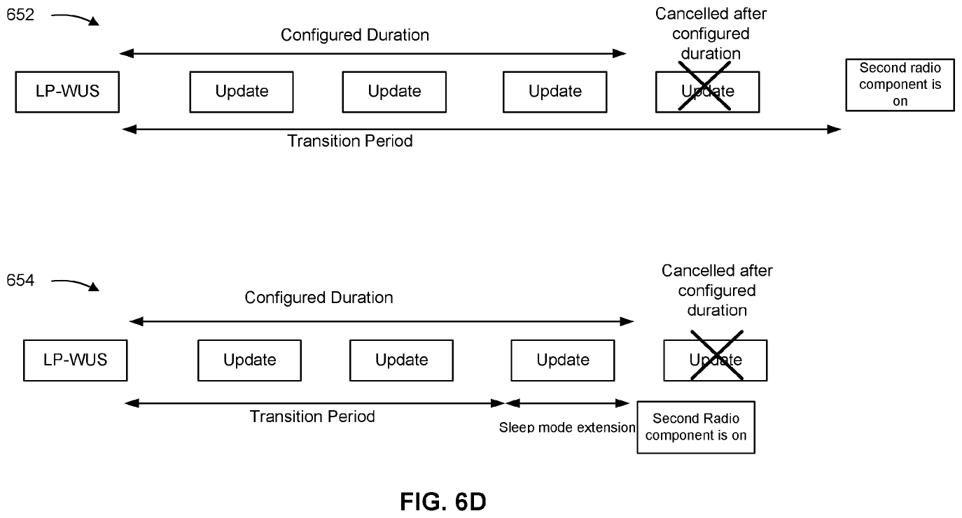

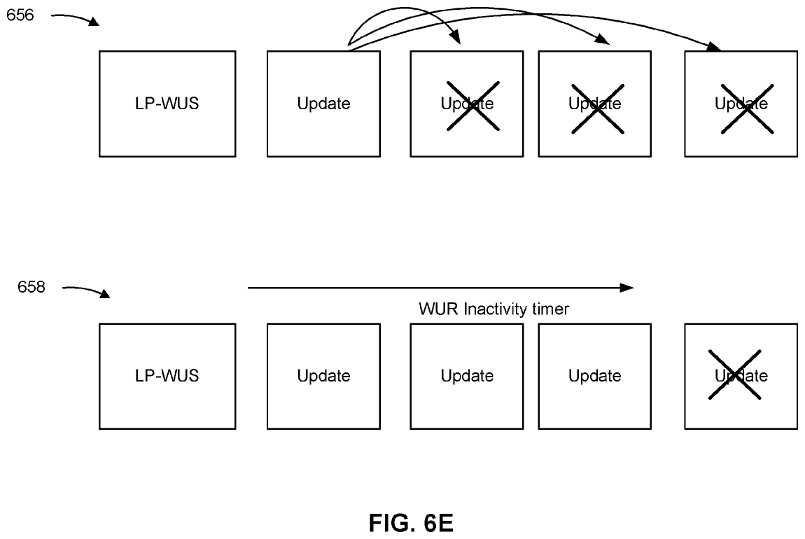

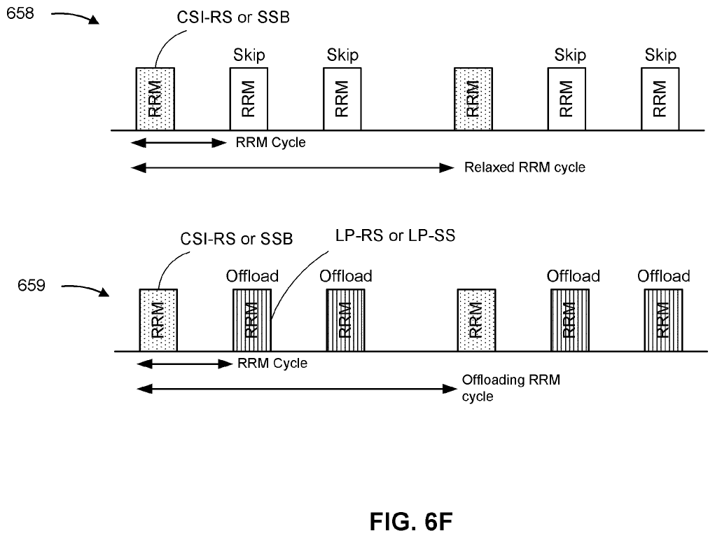

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-10).

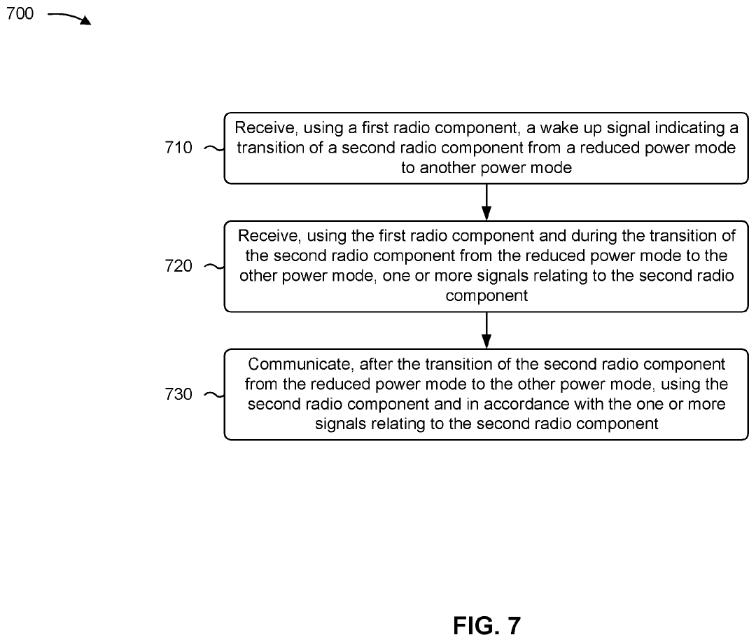

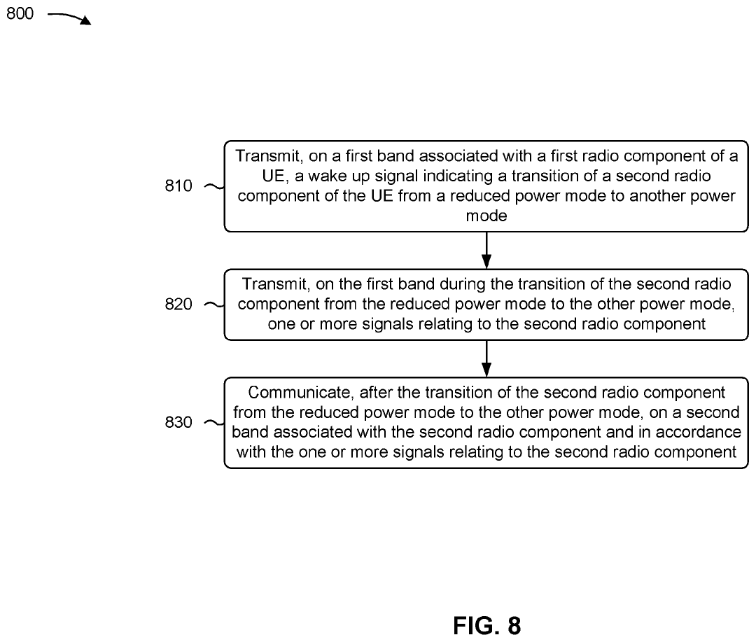

The controller/processor 240 of the network node 110, the controller/processor 280 of the UE 120, and/or any other component(s) of FIG. 2 may perform one or more techniques associated with wake up radio assisted communication during power mode transition, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving, using a first radio component, a wake up signal indicating a transition of a second radio component from a reduced power mode to another power mode; means for receiving, using the first radio component and during the transition of the second radio component from the reduced power mode to the other power mode, one or more signals; and/or means for communicating, after the transition of the second radio component from the reduced power mode to the other power mode, using the second radio component and in accordance with the one or more signals. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, on a first band associated with a first radio component of a UE, a wake up signal indicating a transition of a second radio component of the UE from a reduced power mode to another power mode; means for transmitting, on the first band during the transition of the second radio component from the reduced power mode to the other power mode, one or more signals; and/or means for communicating, after the transition of the second radio component from the reduced power mode to the other power mode, on a second band associated with the second radio component and in accordance with the one or more signals. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

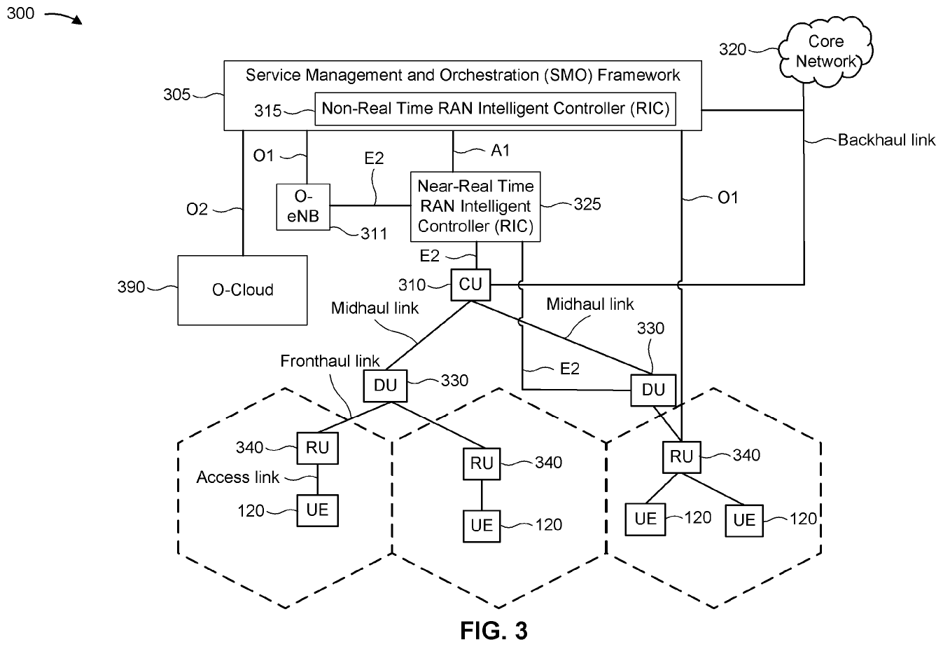

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

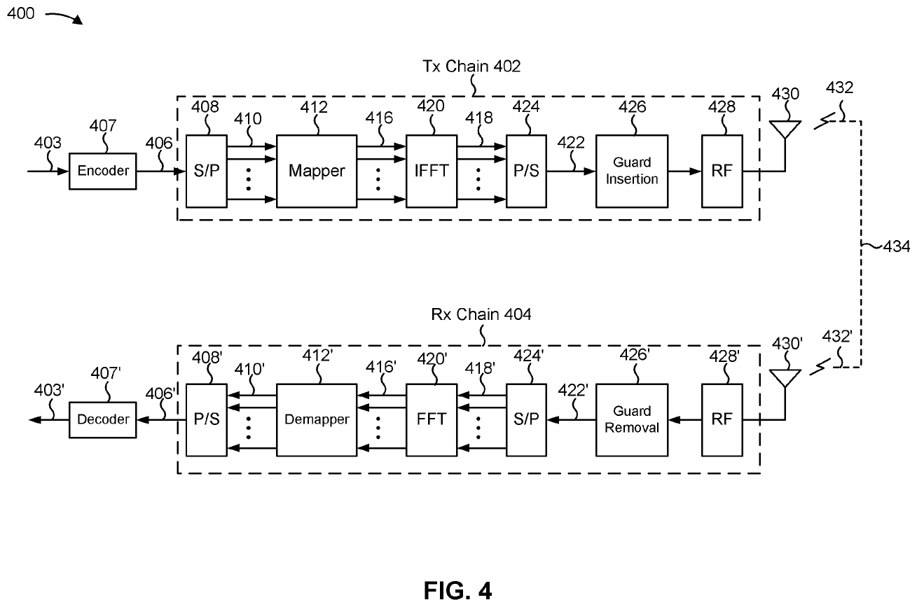

FIG. 4 is a diagram illustrating an example 400 of a transmit (Tx) chain 402 and a receive (Rx) chain 404 of a UE 120, in accordance with the present disclosure. In some aspects, one or more components of Tx chain 402 may be implemented in transmit processor 264, TX MIMO processor 266, modem 254, and/or controller/processor 280, as described above in connection with FIG. 2. In some aspects, Tx chain 402 may be implemented in UE 120 for transmitting data 406 (e.g., uplink data, an uplink reference signal, and/or uplink control information) to a network node 110 on an uplink channel.

An encoder 407 may alter a signal (e.g., a bitstream) 403 into data 406. Data 406 to be transmitted is provided from encoder 407 as input to a serial-to-parallel (S/P) converter 408. In some aspects, S/P converter 408 may split the transmission data into N parallel data streams 410.

The N parallel data streams 410 may then be provided as input to a mapper 412. Mapper 412 may map the N parallel data streams 410 onto N constellation points. The mapping may be done using a modulation constellation, such as binary phase-shift keying (BPSK), quadrature phase-shift keying (QPSK), 8 phase-shift keying (8PSK), quadrature amplitude modulation (QAM), etc. Thus, mapper 412 may output N parallel symbol streams 416, each symbol stream 416 corresponding to one of N orthogonal subcarriers of an inverse fast Fourier transform (IFFT) component 420. These N parallel symbol streams 416 are represented in the frequency domain and may be converted into N parallel time domain sample streams 418 by IFFT component 420.

In some aspects, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol)+N (the number of useful samples per OFDM symbol).

The N parallel time domain sample streams 418 may be converted into an OFDM/OFDMA symbol stream 422 by a parallel-to-serial (P/S) converter 424. A guard insertion component 426 may insert a guard interval between successive OFDM/OFDMA symbols in the OFDM/OFDMA symbol stream 422. The output of guard insertion component 426 may then be upconverted to a desired transmit frequency band by a radio frequency (RF) front end 428. An antenna 430 may then transmit the resulting signal 432.

In some aspects, Rx chain 404 may utilize OFDM/OFDMA. In some aspects, one or more components of Rx chain 404 may be implemented in receive processor 258, MIMO detector 256, modem 254, and/or controller/processor 280, as described above in connection with FIG. 2. In some aspects, Rx chain 404 may be implemented in UE 120 for receiving data 406 (e.g., downlink data, a downlink reference signal, and/or downlink control information) from a network node 110 on a downlink channel.

A transmitted signal 432 is shown traveling over a wireless channel 434 from Tx chain 402 to Rx chain 404. When a signal 432′ is received by an antenna 430′, the received signal 432′ may be downconverted to a baseband signal by an RF front end 428′. A guard removal component 426′ may then remove the guard interval that was inserted between OFDM/OFDMA symbols by guard insertion component 426.

The output of guard removal component 426′ may be provided to an S/P converter 424′. The output may include an OFDM/OFDMA symbol stream 422′, and S/P converter 424′ may divide the OFDM/OFDMA symbol stream 422′ into N parallel time-domain symbol streams 418′, each of which corresponds to one of the N orthogonal subcarriers. A fast Fourier transform (FFT) component 420′ may convert the N parallel time-domain symbol streams 418′ into the frequency domain and output N parallel frequency-domain symbol streams 416′.

A demapper 412′ may perform the inverse of the symbol mapping operation that was performed by mapper 412, thereby outputting N parallel data streams 410′. A P/S converter 408′ may combine the N parallel data streams 410′ into a single data stream 406′. Ideally, data stream 406′ corresponds to data 406 that was provided as input to Tx chain 402. Data stream 406′ may be decoded into a decoded data stream 403′ by decoder 407′.

Some UEs may have multiple transmit chains and/or multiple receive chains. For example, a UE may include a first radio component with a first transmit chain and a first receive chain and a second radio component with a second transmit chain and a second receive chain. In some examples, the first radio component and the second radio component may be separate (e.g., have separate transmit chains that do not share hardware components). In other examples, the first radio component and the second radio component may be conceptually separate (e.g., can be referred to as separate components and may have some separate hardware components, but may share one or more hardware components). In other words, in one example, a first radio component and a second radio component may share a common antenna 430, but may have separate mappers 412, IFFT components 420, or P/S converters 424, among other examples. In some examples, different radio components may have different configurations, such as different monitoring periodicities, different power levels, different processing capabilities, or different tuning bands, among other examples. Different terminologies may be used for radio components in a UE with a plurality of radio components. In some examples, the first (or second) radio component may be referred to as a “primary radio component” or a “main radio component” and the second (or first) radio component may be referred to as a “secondary radio component,” a “wake-up radio component,” or a “low-power wake-up radio component.”

The number and arrangement of components shown in FIG. 4 are provided as an example. In practice, there may be additional components, fewer components, different components, or differently arranged components than those shown in FIG. 4. Furthermore, two or more components shown in FIG. 4 may be implemented within a single component, or a single component shown in FIG. 4 may be implemented as multiple, distributed components. Additionally, or alternatively, a set of components (e.g., one or more components) shown in FIG. 4 may perform one or more functions described as being performed by another set of components shown in FIG. 4.

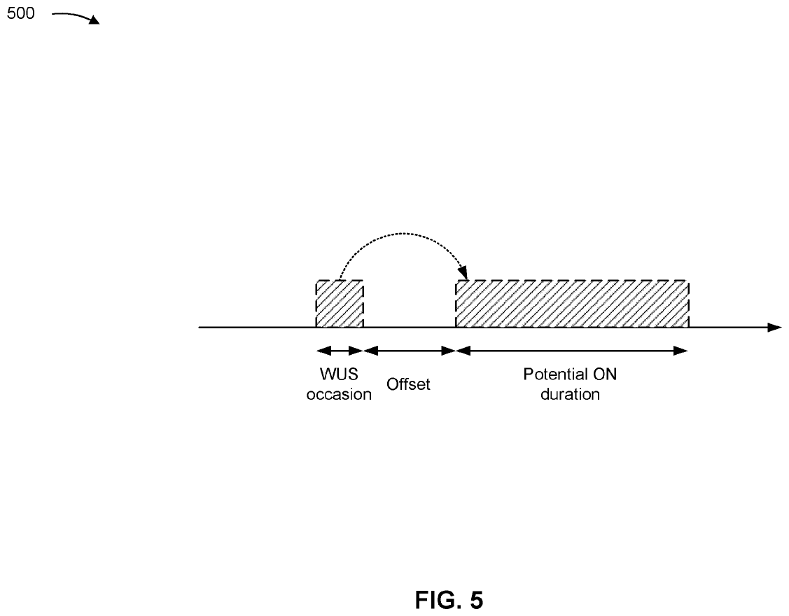

FIG. 5 is a diagram illustrating an example 500 of wake up signaling, in accordance with the present disclosure.

As shown in FIG. 5, in a communication system, a network node and a UE may be configured with a wake up signal (WUS) occasion. During the wake up signal occasion, the network node may transmit a signal to the UE to trigger to the UE to transition from a reduced power mode (e.g., a discontinuous reception (DRX) off state) to another power mode (e.g., a normal power mode, such as a DRX on state associated with a DRX on duration). After transitioning from the reduced power mode to, for example, the normal power mode, the UE may have a period of time when the UE can communicate with the network node. For example, the UE may be configured with a DRX on duration. A start of the DRX on duration may be offset from the wake up signal occasion to provide time for the UE to process and interpret the wake up signal, complete a power mode transition, turn on one or more transmit chain components, or tune an antenna, among other examples.

A dual-radio UE may use a first radio component to monitor for wake up signals and a second radio component to communicate during an on duration. The first radio component may be a low-power wake up radio that is a companion receiver for the second radio component, which may be a main radio. The UE can have the main radio in a sleep state, thereby conserving a usage of power resources, while monitoring for wake up signals using the low-power wake up radio (e.g., which may consume less power resources to perform monitoring than the main radio consumes). When the UE detects a wake up signal with the first radio component, the UE can wake up the second radio component to communicate during the on duration, thereby providing improved communication performance (e.g., the main radio may have a higher transmit power and/or a greater processing capability than the low-power wake up radio, resulting in improved throughput and/or a reduced likelihood of dropped communications).

Additionally, by using a wake-up radio for wake up signaling monitoring, a UE can also perform more frequent wake up signal monitoring. For example, a network node can configure a UE with more frequent wake up signal occasions for monitoring using a low-power wake up radio without adversely impacting power resources than may be possible for monitoring using the main radio. In this case, a delay between data arriving at the network node and a wake up signal occasion occurring is reduced, thereby reducing a latency associated with communications relative to a UE with less frequent wake up signal occasions.

Low-power reference signals (LP-RSs) have been introduced for use with a low-power wake up radio. An LP-RS can be used for, for example, paging reception. Other reference signal functions, such as radio resource management or tracking, may be performed using other types of reference signals associated with the main radio, which, in some cases, the low-power wake up radio may have a computational capability for receiving. For the other types of reference signals, as well as other control information, there may be a latency associated with transmitting a wake up signal to a UE, the UE entering an on duration, and the UE receiving using the main radio. Different low power modes may be associated with different latencies. For example, a first low power mode may have a 6 millisecond (ms) latency for transitioning to an on duration, but a second, even lower power, mode may have a 20 ms or a 50 ms latency. Such even lower power modes may further reduce power consumption but, as described above, may result in increased latency to communicate some information.

A low-power (LP) signal may be any signal, such as one or more of the signals described herein, that may be received by a low-power radio component, such as one or more of the radio components described herein. For example, an LP signal may be a signal transmitted in a frequency band that an LP radio component is configured to monitor or a signal transmitted at a time that the LP radio component is configured to periodically monitor. An LP radio component may be configured to periodically monitor for an LP signal, such as an LP-WUS, a paging indicator, a LP synchronization signal (LP-SS), an LP synchronization preamble signal (LP-sync-preamble signal), or an LP-RS, in accordance with a schedule. For example, the LP radio component may monitor in accordance with a connected mode discontinuous reception (CDRX) cycle or in accordance with a configured period. The period may be configured by a network node (e.g., a serving cell of a UE). The LP-WUS may be an on-off keying (OOK) signal, a sequence-based signal, a coded signal (e.g., PDCCH-based DCI). The LP-WUS or a paging indicator may schedule an LP-RS for the LP radio component to receive. The LP-RS may be any reference signal that may be measured by an LP radio component, for example a CSI-RS, a positioning reference signal (PRS), or a synchronization signal.

As indicated above, FIG. 5 is provided as an example. Other examples may differ from what is described with respect to FIG. 5.

Some aspects described herein enable a UE to use a first radio to receive one or more signals relating to a second radio. For example, a UE may use a wake up radio to monitor for wake up signals and to communicate information associated with a main radio while the main radio remains off or in a low power mode and/or is transitioning to an on duration or a normal power mode. For example, a UE may receive configuration information using LP-RSs or other wake up radio signals (e.g., a wake up signal) and may use the configuration information for configuring and communicating using a main radio. In this case, using the wake up radio to receive the configuration information (e.g., during an offset between a wake up signal occasion and an on duration) reduces a latency associated with configuring the UE relative to waiting until the main radio is available to receive the configuration information directly. Additionally, or alternatively, the network node can use one or more signals transmitted during the offset period to update a configuration of the UE, thereby increasing a configuration flexibility of the UE relative to the UE having a static configuration during the offset period.

FIGS. 6A-6F are diagrams illustrating an example 600 associated with wake up radio assisted communication during power mode transition, in accordance with the present disclosure. As shown in FIG. 6A, example 600 includes communication between a network node 110 and a UE 120.

As further shown in FIG. 6A, and by reference number 605, the UE 120 may receive a wake up signal using a first radio component. For example, the UE 120 may receive the wake up signal using a wake up radio. In some aspects, the UE 120 may initiate a wake up of a second radio component based on receiving the wake up signal, as shown by reference number 610. For example, the UE 120 may parse the wake up signal to determine that the wake up signal includes an indication to change a power mode of a main radio, and may transition the main radio from a reduced power mode to another power mode (e.g., a normal power mode associated with an on duration).

In some aspects, the wake up signal may be a low-power wake up signal (LP-WUS). For example, the UE 120 may receive (e.g., using a low-power wake up radio (LP-WUR)) an LP-WUS that conveys an indication that the UE 120 is to change a mode of the second radio component. In some aspects, the wake up signal may be a reference signal. For example, the UE 120 may receive a low-power reference signal (LP-RS) or a low-power synchronization signal (LP-SS) using the first radio component. Additionally, or alternatively, based at least in part on a UE capability, the UE 120 may receive another reference signal as a wake up signal. For example, when the UE 120 is capable of processing a synchronization signal block (SSB) or channel state information (CSI) reference signal (RS) (CSI-RS) using the first radio component, the network node 110 may use an SSB or CSI-RS as the synchronization or RRM measurement signal (e.g., thereby obviating a need for a dedicated low-power wake up signal).

In some aspects, the wake up signal is a dedicated signal. For example, the wake up signal may have a structure or set of fields for conveying a wake up indication and/or one or more communication parameters (e.g., monitoring parameters, as described herein). Additionally, or alternatively, the wake up signal may be another type of signal that the UE 120 may interpret as a wake up signal. For example, the UE 120 may interpret a radio network temporary identifier (RNTI), scrambling identifier, or reception occasion as indicating that a signal received via the first radio component is a wake up signal. Additionally, or alternatively, the UE 120 may interpret a payload of a message (e.g., a control message) to determine that the message includes a wake up signal (e.g., the message may have an element with an indicator that the message is a wake up signal). In some aspects, the wake up signal may be a low-power signal (e.g., for reception by the first radio component. In some aspects, the wake up signal may be a non-low-power signal (e.g., a standard power signal for reception by any radio component) that the UE 120 receives using the first radio component.

In some aspects, the UE 120 may have the first radio component in an on state to monitor for the wake up signal. For example, the UE 120 may use the first radio component to monitor a set of wake up signal occasions while the second radio component is in the reduced power mode or an off state. In this case, the UE 120 may receive, using the first radio component, a low-power wake up signal during a wake up signal occasion that the UE 120 is monitoring. In some aspects, the UE 120 may receive the wake up signal as a paging early indication. For example, rather than receiving the wake up signal in a wake up signal occasion, the UE 120 may receive the wake up signal using a paging early indication procedure. In this case, one or more update occasions, as described herein, may be paging occasions. In some aspects, the wake up signal may include a UE identifier (ID) or another indication as a wake up signal to obviate a need for the UE 120 to use the second radio component to monitor paging occasions. For example, the wake up signal (or a signal in an update occasion thereafter) may include a UE ID and a paging message, which the UE 120 may interpret to indicate that the wake up signal (or the signal thereafter) is directed to the UE 120 (among one or more other UEs that may receive the signal). In this case, the UE 120 may extend a sleep period of the second radio component by forgoing monitoring for paging during one or more paging occasions configured for the second radio component.

In some aspects, the UE 120 may receive a two-stage wake up signal, as shown in FIG. 6B. For example, the UE 120 may receive a first stage of a wake up signal in a first monitoring occasion. In this case, the first stage of the wake up signal may include, for example, an indication to trigger the second radio component to transition to another power mode for an on duration. Further to the example, the UE 120 may receive a second stage of the wake up signal in a monitoring occasion occurring after the first stage of the wake up signal. In this case, the second stage of the wake up signal may include information cancelling the first stage of the wake up signal, configuring an offset period for monitoring for one or more further signals (e.g., in the “update” occasions), or conveying other control information associated with a wake up signal, as described herein. In some aspects, a configuration of whether the UE 120 is to expect a single-stage or two-stage wake up signal may be conveyed from the network node 110 in configuration information transmitted to the second radio component of the UE 120 when the second radio component is in an on duration.

In some aspects, the UE 120 may receive a permanent equipment identifier (PEI) message in a wake up signal monitoring occasion. For example, when PEI signaling via low-power wake up signals is configured for the UE 120, the network node 110 may transmit the PEI message in the wake up signal monitoring occasion. In this case, the UE 120 may monitor for a wake up signal in one or more update occasions occurring after the wake up signal monitoring occasion. For example, the network node 110 may transmit a dedicated message to the UE 120 or a group-common message to a group of UEs 120 (e.g., with an indicator of UEs 120 to which the message is directed) conveying a wake up signal in an update occasion after using the wake up signal occasion for PEI signaling. In this case, the UE 120 may parse the, for example, group-common message to identify one or more parameters that are specific to the UE 120 for, for example, the offset period or for using the second radio after the offset period. Similarly, when there is a two-stage wake up signal, the second stage of the wake up signal may be a group-common message (e.g., to a same or smaller group than the first stage of the wake up signal), which may include one or more UE-specific parameters for configuring monitoring during the offset period or for configuring the second radio for after the offset period.

In some aspects, the wake up signal does not indicate that the UE 120 is to wake up the second radio component. For example, the network node 110 may be configured such that transmitting the wake up signal is mandatory during the wake up signal occasion. In such a case, the network node 110 may include an indicator in the wake up signal (or may omit an indicator in the wake up signal) to signal the UE 120 to forgo waking up the second radio component when the wake up signal is received. In some aspects, the UE 120 may be configured such that even when there is no wake up signal indication (or there is a signal that conveys an indication to maintain the second radio component in, for example, a sleep state), the UE 120 is able to receive signaling in the one or more update occasions using the first radio component. For example, the UE 120 may be configured with L1/L2/L3 signaling (e.g., via the second radio component when awake or configured in a specification) regarding whether the UE 120 is to monitor the update occasions to receive the one or more signals in the update occasions. In some aspects, a signal, in a wake up signal occasion, indicating that the UE 120 is not to wake up, as described above, may include information indicating whether the UE 120 is to monitor for and/or will receive information in the one or more update occasions. Additionally, or alternatively, when the network node 110 is configured to transmit the wake up signal for other purposes (e.g., PEI signaling or radio resource management), the network node 110 may include an indicator (or omit an indicator) to signal the UE 120 when the wake up signal is not to trigger a transition of the second radio component to a different power mode. When the UE 120 is not triggered to wake up, the UE 120 may forgo monitoring for signaling in one or more update occasions occurring during a period that would be an offset period if the UE 120 had been triggered to wake up.

As further shown in FIG. 6A, and by reference number 615, the UE 120 may receive one or more further signals with the first radio component. For example, during an offset period associated with transitioning the second radio component from a reduced power mode to another power mode, the UE 120 may use the first radio component to receive further signaling, such as signaling associated with configuring the second radio component and/or communications therewith.

In some aspects, the UE 120 may interpret the one or more signals to obtain information being conveyed by the one or more signals. For example, the UE 120 may receive, prior to the wake up signal and using the first radio component when the first radio component is in an on duration, signaling indicating a format for the wake up signal (e.g., network node 110 may transmit layer-1 (L1), layer-2 (L2), or layer-3 (L3) signaling indicating how the UE 120 is to interpret bits of the wake up signal). In this case, the UE 120 may determine that the wake up signal includes one or more fields to parse, such as a wake up activation bit field (e.g., conveying the trigger to initiate wake up of the second radio component), an active time field (e.g., conveying a time duration for waking up the second radio component), an inactivity timer field (e.g., conveying a time duration for cancelling one or more monitoring occasions), an activation field (e.g., indicating whether the UE 120 is to monitor for the one or more signals during the offset period), a configuration field (e.g., configuring one or more monitoring occasions for the UE 120 to monitor), or a capability field (e.g., configuring whether a signal, of the one or more signals, can include a bit to disable or release communication before an end of the offset period), among other examples. Additional details regarding information that can be included in the wake up signal and/or the one or more signals received during the offset period are described below.

In some aspects, the UE 120 may receive the one or more signals during the offset period based at least in part on configuration information received from the network node 110. For example, the UE 120 may receive configuration information (e.g., in the wake up signal or prior to receive the wake up signal) that indicates that the UE 120 is to monitor one or more signaling occasions between receipt of the wake up signal and an expiration of the offset period. Additionally, or alternatively, the UE 120 may be statically configured (e.g., based at least in part on a configuration in a specification) to monitor the one or more signaling occasions. For example, as shown in FIG. 6C, and by reference number 650, the UE 120 receives a low-power wake up signal (LP-WUS) while the second radio component is off and is configured with a set of 4 update occasions for receiving one or more signals while the second radio component is transitioning to an on state. In some aspects, the UE 120 may be configured with dedicated resources for receiving the one or more signals in the set of update occasions configured for monitoring during the offset period. For example, when the UE 120 receives the wake up signal, the wake up signal may trigger a set of periodic or aperiodic resources for the UE 120 to monitor to receive one or more signals.

In some aspects, the UE 120 may receive a particular type of signaling in the one or more signals. For example, the UE 120 may receive information regarding subsequent communications with the second radio component and/or configuration information for the second radio component using one or more low-power signals, such as one or more low-power reference signals or one or more low-power wake up signals. In some aspects, the UE 120 may receive, in the one or more signals, configuration information for the second radio component, such as a physical downlink control channel (PDCCH) configuration, a scheduling request (SR) configuration, a channel state information (CSI) reference signal (RS) (CSI-RS) configuration, a sounding reference signal (SRS) configuration, a monitoring configuration, a downlink allocation or grant, or an uplink allocation or grant, among other examples.

Additionally, or alternatively, the UE 120 may receive an indication of a particular parameter. For example, the UE 120 may receive information identifying a network power/energy saving state or a communication state associated with a network power/energy saving mode. Additionally, or alternatively, the UE 120 may receive information identifying a system information change, such as an indication to monitor a synchronization signal using the first radio component before the second radio component is transitioned to the other power mode or an indication to monitor the synchronization signal using the second radio component after the second radio component is transitioned to the other power mode. Additionally, or alternatively, the UE 120 may receive timing information, such as jitter information (e.g., a jitter range) or packet monitoring information (e.g., a timing to receive a packet and start monitoring a PDCCH, a timing to receive a paging occasion (if the LP-WUS does not contain paging information of the UE, such as a UE ID, or timing to transmit a packet), or a DRX active time offset or duration), among other examples.

Additionally, or alternatively, the UE 120 may receive information identifying a paging monitoring occasion configuration or a DRX configuration (e.g., a duration of a DRX cycle, a selection of a DRX configuration, or an adjustment to a DRX cycle start time). Additionally, or alternatively, the UE 120 may receive information identifying a search space set group (SSSG) index for monitoring using the second radio component, or information identifying or indicating a downlink buffer status report (BSR), among other examples. Additionally, or alternatively, the UE 120 may receive information identifying a configuration of at least one of a configured grant (CG) communication, a semi-persistent scheduling (SPS) communication, a sounding reference signal (SRS), a CSI-RS, or an SR, among other examples, or may receive information indicating an activation or deactivation of an SR, a CG communication, an SPS, an SRS, or a CSI-RS set or resource, among other examples.

Additionally, or alternatively, the UE 120 may receive information indicating a cancellation of a wake up or an indication for the UE 120 to maintain on the same power or sleep state or an indication of a channel access failure. For example, after transmitting the wake up signal, the network node 110 may determine that a received signal strength indicator (RSSI) (or an energy metric or metric to determine a wake up condition) does not satisfy a threshold criterion (e.g., the RSSI is above a threshold value), which may indicate that the UE 120 will not be able to successfully use a resource for communication. Accordingly, the network node 110 may transmit a signal, during the offset period, to cancel the wake up of the second radio component, thereby avoiding the UE 120 unsuccessfully communicating, and maintaining use of the reduced power mode to achieve power savings until communication resources become available.

Additionally, or alternatively, the UE 120 may receive information triggering uplink BSR, CSI, or power headroom report (PHR) reporting. For example, the UE 120 may receive, via the first radio, information indicating that the second radio is to transmit a report to the network node 110 when the second radio becomes available. Additionally, or alternatively, when the first radio component has transmitting capability, the UE 120 may receive information triggering the first radio component to transmit a report on behalf of the UE 120, which may reduce a latency to communicate the report relative to waiting for the second radio component to be available.

Additionally, or alternatively, the UE 120 may receive information associated with a first grant downlink control information (DCI) message using the first radio component. Additionally, or alternatively, the UE 120 may receive, using the first radio component, information associated with decoding a first DCI that will be received using the second radio component. For example, the UE 120 may receive information identifying a limited or restricted search space, an aggregation level, a time resource allocation, a frequency resource allocation, or a DCI configuration for the first DCI that will be received using the second radio component, thereby enabling the UE 120 to successfully receive the first DCI (e.g., an uplink or downlink scheduling DCI) using the second radio component with reduced complexity. Additionally, or alternatively, the UE 120 may receive information indicating a configuration of a PDCCH DCI, such as a modulation and coding scheme (MCS) or a resource block (RB) allocation, or indicating a configuration of a configured grant (e.g., an uplink or downlink grant), thereby reducing a complexity associated with decoding a PDCCH DCI or a configured grant.

In some aspects, a length of time in which the UE 120 monitors for one or more signals may be based at least in part on information included in the wake up signal. For example, when the network node 110 does not have information identifying the reduced power mode that the UE 120 is using for the second radio component (and an associated offset period for the reduced power mode), the network node 110 may indicate, in the wake up signal, a duration for the UE 120 to use the first radio component for monitoring for one or more signals. In some aspects, the network node 110 may indicate other configuration information, such as a configuration of the UEs reduced power mode, a configuration of a network power saving mode, a radio resource management (RRM) configuration (e.g., an RRM measurement configuration, an RRM relaxation configuration, or an RRM offloading configuration), or a set of configurations (e.g., a set of RRM configurations, one of which can be activated in an update occasion), among other examples. In other words, rather than the UE 120 monitoring, using the first radio component, for the offset period, the UE 120 may monitor, using the first radio component, for a network node configured duration that may be shorter than, equal to, or longer than the offset period. For example, as shown in FIG. 6D, and by reference number 652, when the configured duration is shorter than a transition time, the UE 120 cancels monitoring during an update occasion occurring after the configured duration but before an end of the transition period (the network node 110 has indicated that it will only transmit the one or more signals during update occasions within the configured duration).

In contrast, when the UE 120 determines that a transition period (e.g., to switch antennas to the second radio component or otherwise transition the second radio component from the reduced power mode to the normal power mode) is less than the configured duration, the UE 120 may autonomously determine to extend an amount of time that the second radio component is in a sleep mode. For example, as shown in FIG. 6D, and by reference number 654, the transition period is shorter than the configured duration, so the UE 120 extends the sleep mode of the second radio component (or transition to a different type of sleep mode) until after the configured duration is over (when the network node 110 expects the second radio component to be on). In some aspects, the UE 120 may turn the second radio component off (or the first radio component), which may include turning of an radio frequency (RF) component (e.g., in a transmit or receive chain), turning off a hardware component, turning off a software component (e.g., stopping execution of a software module), or turning off a firmware component (e.g., stopping execution of a firmware module), among other examples. Although the sleep mode extension is shown as occurring after the transition period in FIG. 6D for illustration, in practice, the UE 120 may maintain the second radio component in a reduced power mode before initiating the transition period, such that the transition period ends at the same time as the configured duration. In other words, when the transition period is shorter than the configured duration, the UE 120 may delay triggering the transition of the second radio component for a period of time.

In some aspects, the UE 120 may receive, in a first signal during the offset period, an indication to cancel monitoring for one or more second signals during the offset period. For example, as shown in FIG. 6E, and by reference number 656, the UE 120 may receive an indication in a first monitoring occasion during the offset period that cancels monitoring during a second, third, and fourth monitoring occasion during the offset period. In this case, the UE 120 may transition the first radio component to a low power mode to save power when the first radio component is not being used to monitor the second, third, and fourth monitoring occasions, for example. In some aspects, the UE 120 may use an inactivity timer to determine whether to monitor for a signal during the offset period. For example, as further shown in FIG. 6E, and by reference number 658, after receiving the wake up signal, the UE 120 may activate an inactivity timer and, if the UE 120 does not receive a signal during one or more monitoring occasions before expiration of the inactivity timer, the UE 120 may cancel one or more monitoring occasions after expiration of the inactivity timer.

In some aspects, the UE 120 may monitor for the one or more signals based at least in part on an activation indicator. For example, prior to receiving the wake up signal, the UE 120 may receive radio resource control (RRC) signaling, medium access control (MAC) control element (CE) signaling, or downlink control information (DCI) signaling with an indicator that, when the UE 120 receives the wake up signal, the UE 120 is to continue monitoring for the one or more signals using the first radio component. Additionally, or alternatively, the UE 120 may receive the activation indicator in the wake up signal. For example, the wake up signal may include a bit indicator indicating whether or not the UE 120 is to monitor for the one or more signals using the first radio component.

In some aspects, the UE 120 may monitor for signaling relating to radio resource management (RRM). For example, the UE 120 may perform an RRM relaxation procedure for an inter-frequency or intra-frequency serving cell for a serving cell or one of a set of non-serving cells. In RRM relaxation, the UE 120 may be enabled to skip (e.g., not measure or process) one or more signals in one or more RRM occasions during a particular interval of time. In some aspects, the UE 120 may be configured with one or more configurations for RRM relaxation (e.g., which may reduce RRM measurement intervals or times or may stop RRM measurements for a configured time duration). For example, the UE 120 may receive a set of configurations when the second radio component is on (e.g., during connected mode or during inactive or idle mode when the UE 120 has a capability of receiving configuration during inactive or idle mode). In this case, during an update occasion, the UE 120 may receive, as a signal of the one or more signals, a set of transmissions for RRM measurement or an indication of which RRM configuration of the set of RRM configurations the UE 120 is to follow. The UE 120 may monitor for the one or more signals in accordance with an RRM configuration. For example, the UE 120 may skip one or more reception opportunities in accordance with a current RRM configuration. The UE 120 may perform a serving cell or neighbor cell measurement using the first radio component or, after the second radio component is transitioned to an off duration, using the second radio component. In some aspects, the UE 120 may update, configure, or re-configure an RRM measurement configuration of a serving cell or neighbor cell using the wake up signal or the one or more signals occurring during the offset period.

In some aspects, the UE 120 may be configured with a first RRM relaxation configuration with a first set of parameters and a second RRM relaxation configuration with a second set of parameters. The sets of parameters may differ with regard to a periodicity of measurements (which may be referred to as a “relaxation factor”), an offloading factor (when RRM offloading, as described herein, is also configured). As another example, the sets of parameters may differ with regard to one or more thresholds or conditions for RRM. For example, an RRM configuration may have a threshold associated with performing RRM procedures that is a first threshold when an RRM measurement is being performed by the first radio component and a second threshold when the RRM measurement is being performed by the second radio component. Additionally, or alternatively, a threshold may be specific to a type of signal. For example, the UE 120 may have a different thresholds for an RRM procedure associated with RRM based at least in part on whether the UE 120 is measuring an LP-RS, an LP-SS, a CSI-RS, or an SSB, among other examples, as described in more details herein.

In some aspects, the UE 120 may receive, via the first radio component as part of the one or more signals or the wake up signal, information selecting or changing a configured RRM configuration. Additionally, or alternatively, the UE 120 may receive, via the second radio component when available (e.g., in an on duration), information selecting, changing, or configuring an RRM configuration. For example, the UE 120 may receive an indicator of an index value that corresponds to an RRM configuration and the UE 120 may adopt the indicated RRM configuration. In some aspects, the UE 120 may receive a stop RRM measurement indication for a certain time duration, wherein time duration can be statically configured or configured by the network node 110. The configuration (e.g. of the time duration) is performed using the first or second radio component. Alternatively, the configuration is performed using an LP-WUS or an update occasion. In some aspects, the UE 120 may receive an indication of relaxation or offloading of RRM of one or more type (e.g., intra-frequency or inter-frequency or inter-RAT) for one or more of serving or one or more of non-serving cells. In some aspects, the UE 120 may associate different RRM configurations and/or parameters thereof with different cells. For example, the UE 120 may associate a first RRM configuration (e.g., with a first relaxation factor or offloading factor) with a serving cell and a second RRM configuration (e.g., with a second relaxation factor or offloading factor) with a non-serving cell. Additionally, or alternatively, the UE 120 may associate RRM configurations by RRM (e.g., inter-frequency or intra-frequency).

In some aspects, the RRM signaling may be applicable to the first radio component, the second radio component, or both the first radio component and the second radio component. For example, the RRM signaling may be associated with a measurement performed by at least one of the first radio component or the second radio component. In some aspects, the RRM signaling may occur in the updating occasions, as described above, or in the wake up signal described above. In some aspects, the RRM signaling may be an indication to offload one or more RRM measurements from the second radio component to the first radio component or to switch from offloading to have the one or more RRM measurements be performed by the second radio component. In RRM offloading, one or more RRM measurements of one or more signals (e.g., in one or more RRM occasions) may be processed by the first radio component rather than by the second radio component, which had been configured to perform the processing, for a particular interval of time (e.g., a specified amount of time or for an amount of time that the second radio component is off or in a reduced power mode). In some aspects, the UE 120 may be configured with a set of RRM configurations. For example, the UE 120 may have a first RRM configuration without RRM relaxation or RRM offloading and a second RRM configuration with RRM relaxation or RRM offloading. In this case, the UE 120 may periodically switch between the RRM configurations, such as based at least in part on a received signal, a configured periodicity, a state of the second radio component (e.g., when the second radio component is off, the UE 120 may choose the RRM configuration with RRM relaxation or offloading), etc. As shown in FIG. 6F, and by reference number 658, the UE 120 may measure an SSB or CSI-RS during an RRM measurement. The UE 120 may be configured with a set of RRM occasions in accordance with an RRM cycle. When RRM relaxation is enabled, the UE 120 may skip one or more of the RRM occasions in accordance with a relaxed RRM cycle. Similarly, as shown by reference number 659, the UE 120 may have an RRM offloading cycle. In this case, the UE 120 measures an SSB or CSI-RS (e.g., using the second radio component) and offloads an LP-RS or LP-SS measurement to the first radio component in accordance with an offloading RRM cycle. Although RRM relaxation and RRM offloading are shown separately, it is contemplated that an RRM configuration may have both RRM relaxation and RRM offloading and the UE 120 may skip some RRM monitoring occasions or stop RRM monitoring for a certain time duration (e.g., 1 hour) and offload other RRM monitoring occasions (e.g., to the first radio component). In some aspects, an RRM configuration may include, for example, a configuration of which measurements to perform, which radio component to use to perform the measurements, a cycle for skipping one or more RRM occasions, a cycle for offloading one or more RRM measurements, or another parameter.

In some aspects, the one or more signals (or the wake up signal, itself) may trigger a CSI report. For example, the UE 120 may perform CSI-RS or LP-RS processing of a CSI-RS or an LP-RS, respectively. Additionally, or alternatively, the UE 120 may report information regarding a CSI-RS or an LP-RS. For example, the UE 120 may transmit a CSI report based at least in part on a CSI-RS processed by the second radio component or an LP-RS processed by the first radio component. In this case, the UE 120 may transmit the CSI report using the second radio component when the second radio component wakes up using one or more resources. In some aspects, the UE 120 may bundle a plurality of reports into a single resource or may transmit a plurality of reports using a plurality of separate resources (e.g., configured by the network node 110). In some aspects, an LP-RS CSI report (or other channel state feedback (CSF) report) may include information identifying at least one of an RSRP, an RSRQ, an SINR value, an interference level, a CQI, an MCS, a precoding matrix indicator (PMI), a beamforming parameter (e.g., analog beam information), or energy information (e.g., a charging rate, a discharging rate, power consumption level, or an energy level) such as when the UE 120 has an energy harvesting capability (e.g., via radio frequency (RF) transmission harvesting, solar harvesting, or laser harvesting).

As further shown in FIG. 6A, and by reference number 620, the UE 120 may communicate with network node 110 in accordance with a communication configuration. For example, after an expiration of the offset period associated with transitioning the second radio component from a reduced power mode to another power mode, the UE 120 may use the second radio component to communicate with the network node 110. In this case, a configuration of the second radio component may be based at least in part on one or more parameters indicated in the one or more signals that the UE 120 received using the first radio component during the offset period, as described above.

As indicated above, FIGS. 6A-6F is provided as an example. Other examples may differ from what is described with respect to FIGS. 6A-6F.

FIG. 7 is a diagram illustrating an example process 700 performed, for example, by a UE, in accordance with the present disclosure. Example process 700 is an example where the UE (e.g., the UE 120) performs operations associated with wake up radio assisted communication during power mode transition.

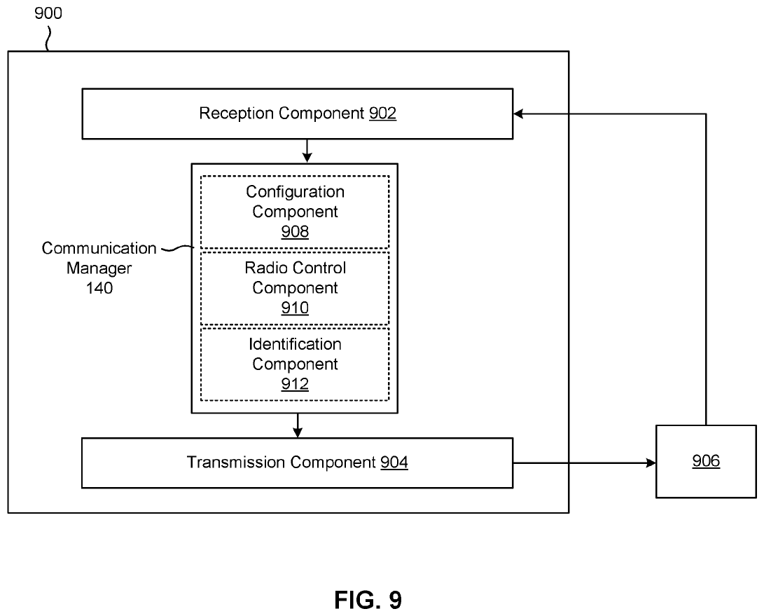

As shown in FIG. 7, in some aspects, process 700 may include receiving, using a first radio component, a wake up signal indicating a transition of a second radio component from a reduced power mode to another power mode (block 710). For example, the UE (e.g., using communication manager 140 and/or reception component 902, depicted in FIG. 9) may receive, using a first radio component, a wake up signal indicating a transition of a second radio component from a reduced power mode to another power mode, as described above. In another example, the rather than or in addition to a wake up signal, the UE may receive a low power signal conveying a configuration.

As further shown in FIG. 7, in some aspects, process 700 may include receiving, using the first radio component and during the transition of the second radio component from the reduced power mode to the other power mode, one or more signals (block 720). For example, the UE (e.g., using communication manager 140 and/or reception component 902, depicted in FIG. 9) may receive, using the first radio component and during the transition of the second radio component from the reduced power mode to the other power mode, one or more signals, as described above. In another example, the rather than during the transition, the UE may receive the one or more signals after receiving the configuration.

As further shown in FIG. 7, in some aspects, process 700 may include communicating, after the transition of the second radio component from the reduced power mode to the other power mode, using the second radio component and in accordance with the one or more signals (block 730). For example, the UE (e.g., using communication manager 140 and/or reception component 902 or transmission component 904, depicted in FIG. 9) may communicate, after the transition of the second radio component from the reduced power mode to the other power mode, using the second radio component and in accordance with the one or more signals, as described above.

Process 700 may include additional aspects, such as any single aspect or any combination of aspects described below and/or in connection with one or more other processes described elsewhere herein.

In a first aspect, process 700 includes receiving configuration information associated with receiving the one or more signals, and configuring the first radio component based on the configuration information, and receiving the one or more signals comprises receiving the one or more signals based on configuring the first radio component.

In a second aspect, alone or in combination with the first aspect, the one or more signals include at least one of a configuration of the second radio component, a physical downlink control channel message, a scheduling request, a reference signal, or a grant.

In a third aspect, alone or in combination with one or more of the first and second aspects, the wake up signal includes information identifying a period of time for receiving the one or more signals.

In a fourth aspect, alone or in combination with one or more of the first through third aspects, receiving the one or more signals comprises receiving the one or more signals based at least in part on at least one a radio resource control configuration, a MAC CE configuration, a downlink control information configuration, a configuration in the wake up signal, or a monitoring duration for the first radio component after receiving the wake up signal.

In a fifth aspect, alone or in combination with one or more of the first through fourth aspects, the monitoring duration is based at least in part on at least one of an antenna switching configuration or a sleep mode duration configuration for the second radio component.

In a sixth aspect, alone or in combination with one or more of the first through fifth aspects, the sleep mode duration configuration is based at least in part on a UE capability or a received indication.

In a seventh aspect, alone or in combination with one or more of the first through sixth aspects, process 700 includes receiving, in the one or more signals, an indication to transition to another power mode of the first radio component, and transitioning the first radio component to the other power mode of the first radio component based at least in part on receiving the indication.

In an eighth aspect, alone or in combination with one or more of the first through seventh aspects, the transition to the other power mode of the first radio component includes at least one of turning off the first radio component, resuming a previous low power mode, or transitioning to another low power mode that is different from the previous low power mode.

In a ninth aspect, alone or in combination with one or more of the first through eighth aspects, process 700 includes identifying an expiration of an inactivity timer associated with receiving the one or more signals, and transitioning the first radio component to an off mode based at least in part on identifying the expiration of the inactivity timer.

In a tenth aspect, alone or in combination with one or more of the first through ninth aspects, process 700 includes receiving control information identifying a mapping of bits of the wake up signal to a set of parameters, and interpreting the wake up signal based at least in part on the control information.

In an eleventh aspect, alone or in combination with one or more of the first through tenth aspects, receiving the wake up signal comprises receiving a first stage of the wake up signal, the first stage of the wake up signal including an indication of the transition, and receiving a second stage of the wake up signal, the second stage of the wake up signal including a field for conveying a cancellation of the wake up signal.

In a twelfth aspect, alone or in combination with one or more of the first through eleventh aspects, the wake up signal is included in one or more bits of a UE-common message or in one or more bits of a UE-dedicated message.

In a thirteenth aspect, alone or in combination with one or more of the first through twelfth aspects, the one or more signals include at least one signal common to a group of UEs from which the UE derives a group-common parameter.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with wake up radio assisted communication during power mode transition.

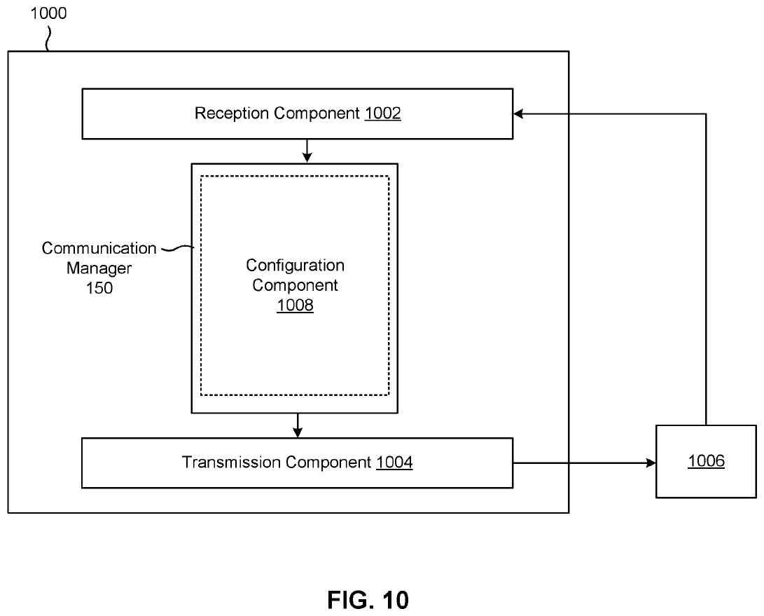

As shown in FIG. 8, in some aspects, process 800 may include transmitting, on a first band associated with a first radio component of a UE, a wake up signal indicating a transition of a second radio component of the UE from a reduced power mode to another power mode (block 810). For example, the network node (e.g., using communication manager 150 and/or transmission component 1004, depicted in FIG. 10) may transmit, on a first band associated with a first radio component of a UE, a wake up signal indicating a transition of a second radio component of the UE from a reduced power mode to another power mode, as described above. In another example, the rather than or in addition to a wake up signal, the network node may transmit a low power signal conveying a configuration.

As further shown in FIG. 8, in some aspects, process 800 may include transmitting, on the first band during the transition of the second radio component from the reduced power mode to the other power mode, one or more signals (block 820). For example, the network node (e.g., using communication manager 150 and/or transmission component 1004, depicted in FIG. 10) may transmit, on the first band during the transition of the second radio component from the reduced power mode to the other power mode, one or more signals, as described above. In another example, the network node may transmit the one or more signals after transmitting the configuration.

As further shown in FIG. 8, in some aspects, process 800 may include communicating, after the transition of the second radio component from the reduced power mode to the other power mode, on a second band associated with the second radio component and in accordance with the one or more signals (block 830). For example, the network node (e.g., using communication manager 150 and/or reception component 1002 or transmission component 1004, depicted in FIG. 10) may communicate, after the transition of the second radio component from the reduced power mode to the other power mode, on a second band associated with the second radio component and in accordance with the one or more signals, as described above.

Process 800 may include additional aspects, such as any single aspect or any combination of aspects described below and/or in connection with one or more other processes described elsewhere herein.

In a first aspect, process 800 includes transmitting configuration information associated with the one or more signals.

In a second aspect, alone or in combination with the first aspect, the one or more signals include at least one of a configuration of the second radio component, a physical downlink control channel message, a scheduling request, a reference signal, or a grant.

In a third aspect, alone or in combination with one or more of the first and second aspects, the wake up signal includes information identifying a period of time for the one or more signals.

In a fourth aspect, alone or in combination with one or more of the first through third aspects, the one or more signals are associated with at least one of a radio resource control configuration, a MAC CE configuration, a downlink control information configuration, a configuration in the wake up signal, or a monitoring duration for the first radio component after receiving the wake up signal.

In a fifth aspect, alone or in combination with one or more of the first through fourth aspects, the monitoring duration is based at least in part on at least one of an antenna switching configuration or a sleep mode duration configuration for the second radio component.

In a sixth aspect, alone or in combination with one or more of the first through fifth aspects, the sleep mode duration configuration is based at least in part on a UE capability or a transmitted indication.

In a seventh aspect, alone or in combination with one or more of the first through sixth aspects, process 800 includes transmitting, in the one or more signals, an indication to transition to another power mode of the first radio component.

In an eighth aspect, alone or in combination with one or more of the first through seventh aspects, process 800 includes transmitting control information identifying a mapping of bits of the wake up signal to a set of parameters.

In a ninth aspect, alone or in combination with one or more of the first through eighth aspects, transmitting the wake up signal comprises transmitting a first stage of the wake up signal, the first stage of the wake up signal including an indication of the transition, and transmitting a second stage of the wake up signal, the second stage of the wake up signal including a field for conveying a cancellation of the wake up signal.

In a tenth aspect, alone or in combination with one or more of the first through ninth aspects, the wake up signal is included in one or more bits of a UE-common message or in one or more bits of a UE-dedicated message.

In an eleventh aspect, alone or in combination with one or more of the first through tenth aspects, the one or more signals include at least one signal common to a group of UEs from which the UE derives a group-common parameter.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a configuration component 908, a radio control component 910, or an identification component 912, among other examples.

In some aspects, the apparatus 900 may be configured to perform one or more operations described herein in connection with FIGS. 6A-6F. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, using a first radio component, a wake up signal indicating a transition of a second radio component from a reduced power mode to another power mode. The reception component 902 may receive, using the first radio component and during the transition of the second radio component from the reduced power mode to the other power mode, one or more signals. The reception component 902 or the transmission component 904 may communicate, after the transition of the second radio component from the reduced power mode to the other power mode, using the second radio component and in accordance with the one or more signals.

The reception component 902 may receive configuration information associated with receiving the one or more signals. The configuration component 908 may configure the first radio component based on the configuration information. The reception component 902 may receive, in the one or more signals, an indication to transition to another power mode of the first radio component. The radio control component 910 may transition the first radio component to the other power mode of the first radio component based at least in part on receiving the indication. The identification component 912 may identify an expiration of an inactivity timer associated with receiving the one or more signals. The radio control component 910 may transition the first radio component to an off mode based at least in part on identifying the expiration of the inactivity timer. The reception component 902 may receive control information identifying a mapping of bits of the wake up signal to a set of parameters. The configuration component 908 may interpret the wake up signal based at least in part on the control information.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a configuration component 1008, among other examples.

In some aspects, the apparatus 1000 may be configured to perform one or more operations described herein in connection with FIGS. 6A-6F. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The transmission component 1004 may transmit, on a first band associated with a first radio component of a UE, a wake up signal indicating a transition of a second radio component of the UE from a reduced power mode to another power mode. The transmission component 1004 may transmit, on the first band during the transition of the second radio component from the reduced power mode to the other power mode, one or more signals. The reception component 1002 or the transmission component 1004 may communicate, after the transition of the second radio component from the reduced power mode to the other power mode, on a second band associated with the second radio component and in accordance with the one or more signals.

The transmission component 1004 may transmit configuration information associated with the one or more signals. The transmission component 1004 may transmit, in the one or more signals, an indication to transition to another power mode of the first radio component. The transmission component 1004 may transmit control information identifying a mapping of bits of the wake up signal to a set of parameters. The configuration component 1008 may generate control information that is transmitted to the apparatus 1006 to control, for example, a radio component of the apparatus 1006.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

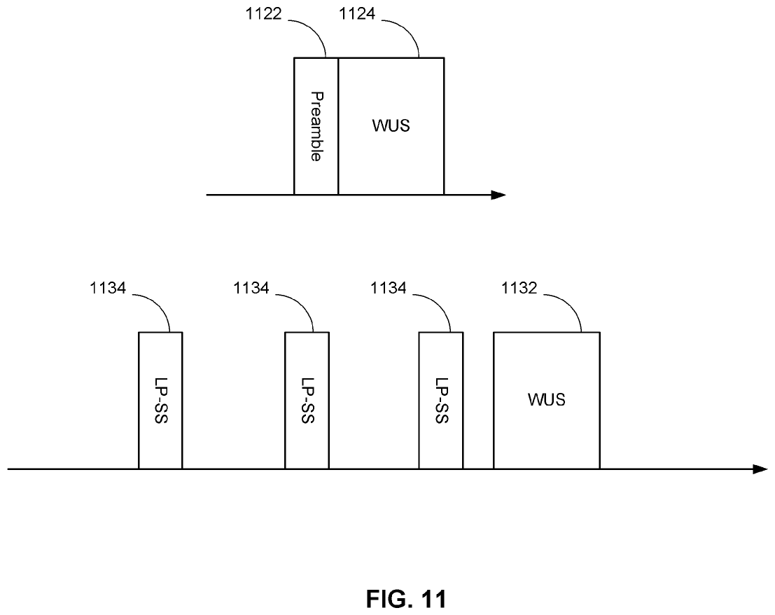

FIG. 11 is a diagram illustrating an example 1100 of wake up signaling, in accordance with the present disclosure.

As shown in FIG. 11, an LP-WUS 1132 may include a preamble 1122 and a wake up indicator 1124 of the LP-WUS 1132. A set of communications for receipt using an LP-WUR may include a set of LP-SSs 1134 and an LP-WUS 1132.

The LP-WUS 1132 may be a signal that is similar to an NR WUS, which is a PDCCH-based DCI with polar coding (e.g., a coded control signal, such as DCI). The LP-WUS 1132 may also be a sequence-based signal including, but not limited to a signal using a sequence associated with discrete Fourier transform (DFT), a Gold code, amplitude shift keying (ASK), phase shift keying (PSK), pulse-position modulation (PPM), pulse-width modulation (PWM), pulse-amplitude modulation (PAM), Walsh codes, m-sequences, Zadoff-Chu sequences, Reed-Solomon codes, or another type of coded signal. The LP-WUS may also be an on-off keying (OOK)-based waveform signal. The waveform may be OFDM, modulating the time domain signal with low and high voltage signals.

An LP-RS (not shown) may be a sequence-based signal including, but not limited to a signal associated with DFT, Gold codes, ASK, PSK, PPM, PWM, PAM, Walsh codes, m-sequence, Zadoff-Chu sequences, or Reed-Solomon codes, among other examples. The LP-RS may also be an OOK-based waveform signal. The waveform may be OFDM, DFT-s-OFDM, signal carrier, or SC-QAM, modulating the time domain signal with different voltages.

The LP-SS 1134 or another LP-preamble-synchronization signal may be a sequence-based signal similar to an SSB's PSS or an SSB's SSS. The LP-SS may also be a time domain sequence-based signal which is modulating the time domain signal with a sequence. The LP-SS may also be an OOK-based waveform signal. The waveform may be OFDM, modulating the time domain signal with low and high voltage signals.

Some aspects may include: an indication of “stop” RRM for one or more of serving cell or non-serving cell of one or more types for a certain duration X, wherein X is L1/L2/L3 configured through a MR or a WUR using LP-WUS or one of update signals or low power signal. Some aspects may include: an indication of relaxation and a relaxation factor. Relaxation may have a skip or a stop for a duration for non-serving cells only (and for the MR), in some aspects. Some aspects may include: an indication of offloading to a WUR and an offload factor or duration or configuration. Some aspects may include: offloading for duration (e.g., configured using L1/L2/L3 for MR or L1/L2/L3 for WUR or using LP-WUS or update occasion). This may be for serving cell or non-serving cells and also for one or more types of measurement (e.g., inter-frequency or intra-frequency measurements. In some aspects, a UE 120 can be indicated with 1 bit to relax RRM or with 1 bit for offloading or with one or more bits for relaxation and offloading. Then, a relaxation or offloading configuration can be used. Some aspects may use a plurality of bits to indicate: relax RRM of serving cell (or non-serving cell or a certain type) and a relaxation configuration is a particular configuration (e.g., one of plurality of known configurations). In another case, the plurality of bits may indicate that a relaxation factor is a particular value. Similar bit indicators can be used for offloading. A combination of bit indications can be used for relaxation and offloading. In some examples, a relax or stop can also be signaled (a network node 110) can indicate to an MR or a WUR how to operate during a particular duration). Then, if the network node 110 can switch between both using the MR or the WUR (using an LP signal or WUS or update occasion for communication).

As indicated above, FIG. 11 is provided as an example. Other examples may differ from what is described with respect to FIG. 11.

The following provides an overview of some Aspects of the present disclosure:
Aspect 1: A method of wireless communication performed by an apparatus of a user equipment (UE), comprising: receiving, using a first radio component, a wake up signal indicating a transition of a second radio component from a reduced power mode to another power mode; receiving, using the first radio component and during the transition of the second radio component from the reduced power mode to the other power mode, one or more signals; and communicating, after the transition of the second radio component from the reduced power mode to the other power mode, using the second radio component and in accordance with the one or more signals.
Aspect 2: The method of Aspect 1, further comprising: receiving configuration information associated with receiving the one or more signals; and configuring the first radio component based on the configuration information; and wherein receiving the one or more signals comprises: receiving the one or more signals based on configuring the first radio component.
Aspect 3: The method of any of Aspects 1 to 2, wherein the one or more signals include at least one of: a configuration of the first radio component, a physical downlink control channel message scheduling receipt of data via the first radio component, the data scheduled by the physical downlink control message, a scheduling request, a reference signal, a paging occasion, a paging message, a channel state information report, a UE power saving configuration, a network power saving configuration, a reference signal used for channel estimation or time and frequency synchronization and tracking, a radio resource management (RRM) configuration, a selection of an RRM configuration from a plurality of configured RRM configurations, an RRM measurement configuration, a measurement associated with an RRM relaxation configuration, an RRM offloading configuration, an RRM measurement, a grant for the second radio component, or a grant for the first radio component.
Aspect 4: The method of any of Aspects 1 to 3, further comprising: receiving, using the second radio component and before the second radio component is in the reduced power mode, configuration information, the configuration information relating to the one or more signals.
Aspect 5: The method of any of Aspects 1 to 4, wherein receiving the one or more signals comprises: receiving the one or more signals based at least in part on at least one: a radio resource control configuration, a medium access control (MAC) control element configuration, a downlink control information configuration, a configuration in the wake up signal, or a monitoring duration for the first radio component after receiving the wake up signal.
Aspect 6: The method of Aspect 5, wherein the monitoring duration is based at least in part on at least one of an antenna switching configuration or a sleep mode duration configuration for the second radio component.
Aspect 7: The method of Aspect 6, wherein the sleep mode duration configuration is based at least in part on a UE capability or a received indication.
Aspect 8: The method of any of Aspects 1 to 7, further comprising: receiving, in the one or more signals, an indication to transition to another power mode of the first radio component; and transitioning the first radio component to the other power mode of the first radio component based at least in part on receiving the indication.
Aspect 9: The method of Aspect 8, wherein the transition to the other power mode of the first radio component includes at least one of: turning off the first radio component, resuming a previous low power mode, or transition to another low power mode that is different from the previous low power mode.
Aspect 10: The method of any of Aspects 1 to 9, further comprising: identifying an expiration of an inactivity timer associated with receiving the one or more signals; and transitioning the first radio component to an off mode based at least in part on identifying the expiration of the inactivity timer, wherein to turn off the first radio component, the UE is to turn off a radio frequency (RF) component, turn of a hardware (HW) component, turn off a software (SW) component, or turn off a firmware (FW) component.
Aspect 11: The method of any of Aspects 1 to 10, further comprising: receiving control information identifying a mapping of bits of the wake up signal to a set of parameters; and interpreting the wake up signal based at least in part on the control information.
Aspect 12: The method of any of Aspects 1 to 11, wherein receiving the wake up signal comprises: receiving a first stage of the wake up signal, the first stage of the wake up signal including an indication of the transition; and receiving a second stage of the wake up signal, the second stage of the wake up signal including a field for conveying a cancellation of the wake up signal.
Aspect 13: The method of any of Aspects 1 to 12, wherein the wake up signal is included in one or more bits of a UE-common message or in one or more bits of a UE-dedicated message.
Aspect 14: The method of any of Aspects 1 to 13, wherein the one or more signals include at least one signal common to a group of UEs from which the UE derives a group-common parameter.
Aspect 15: A method of wireless communication performed by an apparatus of a network node, comprising: transmitting, on a first band associated with a first radio component of a user equipment (UE), a wake up signal indicating a transition of a second radio component of the UE from a reduced power mode to another power mode; transmitting, on the first band during the transition of the second radio component from the reduced power mode to the other power mode, one or more signals; and communicating, after the transition of the second radio component from the reduced power mode to the other power mode, on a second band associated with the second radio component and in accordance with the one or more signals.
Aspect 16: The method of Aspect 15, further comprising: transmitting configuration information associated with the one or more signals.
Aspect 17: The method of any of Aspects 15 to 16, wherein the one or more signals include at least one of: a configuration of the second radio component, a physical downlink control channel message, a scheduling request, a reference signal, or a grant.
Aspect 18: The method of any of Aspects 15 to 17, wherein the wake up signal includes information identifying a period of time for the one or more signals.
Aspect 19: The method of any of Aspects 15 to 18, wherein the one or more signals are associated with at least one of: a configuration of the first radio component, a physical downlink control channel message scheduling receipt of data via the first radio component, the data scheduled by the physical downlink control message, a scheduling request, a reference signal, a paging occasion, a paging message, a channel state information report, a UE power saving configuration, a network power saving configuration, a reference signal used for channel estimation or time and frequency synchronization and tracking, a radio resource management (RRM) configuration, a selection of an RRM configuration from a plurality of configured RRM configurations, an RRM measurement configuration, a measurement associated with an RRM relaxation configuration, an RRM offloading configuration, an RRM measurement, a grant for the second radio component, or a grant for the first radio component.
Aspect 20: The method of Aspect 19, wherein the monitoring duration is based at least in part on at least one of an antenna switching configuration or a sleep mode duration configuration for the second radio component.
Aspect 21: The method of Aspect 20, wherein the sleep mode duration configuration is based at least in part on a UE capability or a transmitted indication.
Aspect 22: The method of any of Aspects 15 to 21, further comprising: transmitting, in the one or more signals, an indication to transition to another power mode of the first radio component.
Aspect 23: The method of any of Aspects 15 to 22, further comprising: transmitting control information identifying a mapping of bits of the wake up signal to a set of parameters.
Aspect 24: The method of any of Aspects 15 to 23, wherein transmitting the wake up signal comprises: transmitting a first stage of the wake up signal, the first stage of the wake up signal including an indication of the transition; and transmitting a second stage of the wake up signal, the second stage of the wake up signal including a field for conveying a cancellation of the wake up signal.
Aspect 25: The method of any of Aspects 15 to 24, wherein the wake up signal is included in one or more bits of a UE-common message or in one or more bits of a UE-dedicated message.
Aspect 26: The method of any of Aspects 15 to 25, wherein the one or more signals include at least one signal common to a group of UEs from which the UE derives a group-common parameter.
Aspect 27: An apparatus for wireless communication at a device, comprising a processor; memory coupled with the processor; and instructions stored in the memory and executable by the processor to cause the apparatus to perform the method of one or more of Aspects 1-14.
Aspect 28: A device for wireless communication, comprising a memory and one or more processors coupled to the memory, the one or more processors configured to perform the method of one or more of Aspects 1-14.
Aspect 29: An apparatus for wireless communication, comprising at least one means for performing the method of one or more of Aspects 1-14.
Aspect 30: A non-transitory computer-readable medium storing code for wireless communication, the code comprising instructions executable by a processor to perform the method of one or more of Aspects 1-14.
Aspect 31: A non-transitory computer-readable medium storing a set of instructions for wireless communication, the set of instructions comprising one or more instructions that, when executed by one or more processors of a device, cause the device to perform the method of one or more of Aspects 1-14.
Aspect 32: An apparatus for wireless communication at a device, comprising a processor; memory coupled with the processor, and instructions stored in the memory and executable by the processor to cause the apparatus to perform the method of one or more of Aspects 15-26.
Aspect 33: A device for wireless communication, comprising a memory and one or more processors coupled to the memory, the one or more processors configured to perform the method of one or more of Aspects 15-26.
Aspect 34: An apparatus for wireless communication, comprising at least one means for performing the method of one or more of Aspects 15-26.
Aspect 35: A non-transitory computer-readable medium storing code for wireless communication, the code comprising instructions executable by a processor to perform the method of one or more of Aspects 15-26.
Aspect 36: A non-transitory computer-readable medium storing a set of instructions for wireless communication, the set of instructions comprising one or more instructions that, when executed by one or more processors of a device, cause the device to perform the method of one or more of Aspects 15-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
memory; and
one or more processors, coupled to the memory, configured to:
receive, using a first radio component, a wake up signal indicating a transition of a second radio component from a reduced power mode to another power mode or a configuration;
receive, using the first radio component and during the transition of the second radio component from the reduced power mode to the other power mode or based at least in part on the configuration, one or more signals; and
communicate, after the transition of the second radio component from the reduced power mode to the other power mode or after receiving the configuration, using the second radio component and in accordance with the one or more signals.

2. The UE of claim 1, wherein the wake up signal or the one or more signals includes an indication that the UE is to stay in the same state.

3. The UE of claim 1, wherein the wake up signal or the one or more signals includes at least one of:
an indication to change radio resource management (RRM) for one or more serving cells or non-serving cells of one or more types, or
an indication of a duration for the change that has been configured through the second radio component or through the first radio component using a low-power signal or an update signal.

4. The UE of claim 1, wherein the wake up signal or the one or more signals includes at least one of:
an indication of radio resource management (RRM) relaxation, or
a relaxation factor for RRM relaxation.

5. The UE of claim 1, wherein the wake up signal or the one or more signals includes at least one of:
an indication to offload to the first radio component,
an offload factor,
an offload duration, or
an offload configuration.

6. The UE of claim 1, wherein the UE is configured with at least one of:
an offload duration configured via the first radio component or configured the second radio component using a low power signal,
a stop for the offload duration,
a measurement for which the offload duration is applicable, or
a one or more bit indicator of radio resource management (RRM) relaxation or offloading or one or more parameters thereof.

7. The UE of claim 1, wherein the one or more processors are further configured to:
receive at least one of configuration information associated with receiving the one or more signals, receiving one or more signals relating to first radio; and
configure the first radio component based on the configuration information; and
wherein the one or more processors, to receive the one or more signals, are configured to:
receive the one or more signals based on configuring the first radio component.

8. The UE of claim 1, wherein the one or more processors are further configured to:
receive, using the second radio component and before the second radio component is in the reduced power mode, configuration information, the configuration information relating to the one or more signals.

9. (canceled)

10. The UE of claim 1, wherein the wake up signal includes information identifying a period of time for receiving the one or more signals.

11. The UE of claim 1, wherein the one or more processors, to receive the one or more signals, are configured to:
receive the one or more signals based at least in part on at least one of:
a radio resource control configuration,
a medium access control (MAC) control element configuration,
a downlink control information configuration,
a configuration in the wake up signal, or
a monitoring duration for the first radio component after receiving the wake up signal.

12-13. (canceled)

14. The UE of claim 1, wherein the one or more processors are further configured to:
receive, in the one or more signals, an indication to transition to another power mode of the first radio component; and
transition the first radio component to the other power mode of the first radio component based at least in part on receiving the indication.

15. (canceled)

16. The UE of claim 1, wherein the one or more processors are further configured to:
identify an expiration of an inactivity timer associated with receiving the one or more signals; and
transition the first radio component to an off mode based at least in part on identifying the expiration of the inactivity timer.

17. The UE of claim 1, wherein the one or more processors are further configured to:
receive control information identifying a mapping of bits of the wake up signal to a set of parameters; and
interpret the wake up signal based at least in part on the control information.

18. The UE of claim 1, wherein the one or more processors, to receive the wake up signal, are configured to:
receive a first stage of the wake up signal, the first stage of the wake up signal including an indication of the transition; and
receive a second stage of the wake up signal, the second stage of the wake up signal including a field for conveying a cancellation of the wake up signal.

19. The UE of claim 1, wherein the wake up signal is included in one or more bits of a UE-common message or in one or more bits of a UE-dedicated message.

20. The UE of claim 1, wherein the one or more signals include at least one signal common to a group of UEs from which the UE derives a group-common parameter.

21. A network node for wireless communication, comprising:
memory; and
one or more processors, coupled to the memory, configured to:
transmit, on a first band associated with a first radio component of a user equipment (UE), a wake up signal indicating a transition of a second radio component of the UE from a reduced power mode to another power mode or a configuration;
transmit, on the first band during the transition of the second radio component from the reduced power mode to the other power mode, one or more signals or based at least in part on the configuration; and
communicate, after the transition of the second radio component from the reduced power mode to the other power mode or after transmitting the configuration, on a second band associated with the second radio component and in accordance with the one or more signals.

22-24. (canceled)

25. The network node of claim 21, wherein the one or more signals are associated with at least one of:
a radio resource control configuration,
a medium access control (MAC) control element configuration,
a downlink control information configuration,
a configuration in the wake up signal, or
a monitoring duration for the first radio component after receiving the wake up signal.

26-27. (canceled)

28. The network node of claim 21, wherein the one or more processors are further configured to:
transmit, in the one or more signals, an indication to transition to another power mode of the first radio component.

29. A method of wireless communication performed by a user equipment (UE), comprising:
receiving, using a first radio component, a wake up signal indicating a transition of a second radio component from a reduced power mode to another power mode or a configuration;
receiving, using the first radio component and during the transition of the second radio component from the reduced power mode to the other power mode or based at least in part on the configuration, one or more signals; and
communicating, after the transition of the second radio component from the reduced power mode to the other power mode or after receiving the configuration, using the second radio component and in accordance with the one or more signals.

30. (canceled)
